(19) United States
(12) Patent Application Publication
(10) Pub. No.: US 2003/0107592 A1
(43) Pub. Date: Jun. 12, 2003

(54) System and method for retrieving information related to persons in video programs

(75) Inventors: Dongge Li, Ossining, NY (US); Nevenka Dimitrova, Yorktown Heights, NY (US); Lalitha Agnihotri, Fishkill, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/014,234

(22) Filed: Dec. 11, 2001

(51) Int. Cl. G09G 5/00

(52) U.S. Cl. 345/745

(57) ABSTRACT

An information tracking device receives content data, such as a video or television signal from one or more information sources and analyzes the content data according to a query criteria to extract relevant stories. The query criteria utilizes a variety of information, such as but not limited to a user request, a user profile, and a knowledge base of known relationships. Using the query criteria, the information tracking device calculates a probability of a person or event occurring in the content data and spots and extracts stories accordingly. The results are index, ordered, and then displayed on a display device.

### FIELD OF THE INVENTION

The present invention relates to a person tracker and method of retrieving information related to a targeted person from multiple information sources.

### BACKGROUND OF INVENTION

With some 500+ channels of available television content and endless streams of content accessible via the Internet, it might seem that one would always have access to desirable content. However, to the contrary, viewers are often unable to find the type of content they are seeking. This can lead to a frustrating experience.

When a user watches television there often occur times when the user would be interested in learning further information about persons in the program the user is watching. Present systems, however, fail to provide a mechanism for retrieving information related to a targeted subject, such as an actor or actress, or an athlete. For example, EP 1 031 964 is directed to an automated search device. For example, a user with access to 200 television stations speaks his desire for watching, for example, Robert Redford movies or games shows. Voice recognition systems cause a search of available content and present the user with selections based on the request. Thus, the system is an advanced channel selecting system and does not go outside the presented channels to obtain additional information for the user. Further, U.S. Pat. No. 5,596,705 presents the user with a multi-level presentation of, for example, a movie. The viewer can watch the movie or with the system, formulate queries to obtain additional information regarding the movie. However, it appears that the search is of a closed system of movie related content In contrast, the disclosure of invention goes outside of the available television programs and outside of a single source of content. Several examples are given. A user is watching a live cricket match and can retrieve detailed statistics on the player at bat. A user watching a movie wants to know more about the actor on the screen and additional information is located from various web sources, not a parallel signal transmitted with the movie. A user sees an actress on the screen who looks familiar, but can't remember her name. The system identifies all the programs the user has watched that the actress has been in. Thus, the proposal represents a broader, or open-ended search system for accessing a much larger universe content than either of the two cited references.

On the Internet, a user looking for content can type a search request into a search engine. However, these search engines are often hit or miss and can be very inefficient to use. Furthermore, current search engines are unable to continuously access relevant content to update results over time. There are also specialized web sites and news groups (e.g., sports sites, movie sites, etc.) for users to access. However, these sites require users to log in and inquire about a particular topic each time the user desires information.

Moreover, there is no system available that integrates information retrieving capability across various media types, such as television and the Internet, and can extract people or stories about such persons from multiple channels and site. In one system, disclosed in EP915621, URLs are embedded in a closed caption portion of a transmission so that the URLs can be extracted to retrieve the corresponding web pages in synchronization with the television signal. However, such systems fail to allow for user interaction.

Thus there is a need for a system and method for permitting a user to create a targeted request for information, which request is processed by a computing device having access to multiple information sources to retrieve information related to the subject of the request.

### SUMMARY OF THE INVENTION

The present invention overcomes the shortcomings of the prior art. Generally, a person tracker comprises a content analyzer comprising a memory for storing content data received from an information source and a processor for executing a set of machine-readable instructions for analyzing the content data according to query criteria. The person tracker further comprises an input device communicatively connected to the content analyzer for permitting a user to interact with the content analyzer and a display device communicatively connected to the content analyzer for displaying a result of analysis of the content data performed by the content analyzer. According to the set of machine-readable instructions, the processor of the content analyzer analyzes the content data to extract and index one or more stories related to the query criteria.

More specifically, in an exemplary embodiment, the processor of the content analyzer uses the query criteria to spot a subject in the content data and retrieve information about the spotted person to the user. The content analyzer also further comprises a knowledge base which includes a plurality of known relationships including a map of known faces and voices to names and other related information. The celebrity finder system is implemented based on the fusion of cues from audio, video and available video-text or closed-caption information. From the audio data, the system can recognize speakers based on the voice. From the visual cues, the system can track the face trajectories and recognize faces for each of the face trajectories. Whenever available, the system can extract names from video text and close caption data. A decision-level fusion strategy can then be used to integrate different cues to reach a result. When the user sends a request related to the identify of the person shown on the screen, the person tracker can recognize that person according to the embedded knowledge, which may be stored in the tracker or loaded from a server. Appropriate responses can then be created according to the identification results. If additional or background information is desired, a request may also be sent to the server, which then searches through a candidate list or various external sources, such as the Internet (e.g., a celebrity web site) for a potential answer or clues that will enable the content analyzer to determine an answer.

In general, the processor, according to the machine readable instructions performs several steps to make the most relevant matches to a user's request or interests, including but not limited to person spotting, story extraction, inferencing and name resolution, indexing, results presentation, and user profile management. More specifically, according to an exemplary embodiment, a person spotting function of the machine-readable instructions extracts faces, speech, and text from the content data, makes a first match of known faces to the extracted faces, makes a second match of known voices to the extracted voices, scans the extracted text to make a third match to known names, and calculates a probability of a particular person being present in the content data based on the first, second, and third matches. In addition, a story extraction function preferably segments audio, video and transcript information of the content data, performs information fusion, internal story segmentation/annotation, and inferencing and name resolution to extract relevant stories.

The above and other features and advantages of the present invention will become readily apparent from the following detailed description thereof, which is to be read in connection with the accompanying drawings.

### BRIEF DESCRIPTION OF THE DRAWINGS

In the drawing figures, which are merely illustrative, and wherein like reference numerals depict like elements throughout the several views:

FIG. 1 is a schematic diagram of an overview of an exemplary embodiment of an information retrieval system in accordance with the present invention;

FIG. 2 is a schematic diagram of an alternate embodiment of an information retrieval system in accordance with the present invention;

FIG. 3 is a is a flow diagram of a method of information retrieval in accordance with the present invention;

FIG. 4 is a flow diagram of a method of person spotting and recognition in accordance with the present invention;

FIG. 5 is a flow diagram of a method of story extraction; and

FIG. 6 is a flow diagram of a method of indexing the extracted stories.

### DETAILED DESCRIPTION OF THE PREFERRED EMBODIMENTS

The present invention is directed to an interactive system and method for retrieving information from multiple media sources according to a request of a user of the system.

In particular, an information retrieval and tracking system is communicatively connected to multiple information sources. Preferably, the information retrieval and tracking system receives media content from the information sources as a constant stream of data. In response to a request from a user (or triggered by a user's profile), the system analyzes the content data and retrieves that data most closely related to the request. The retrieved data is either displayed or stored for later display on a display device.

System Architecture

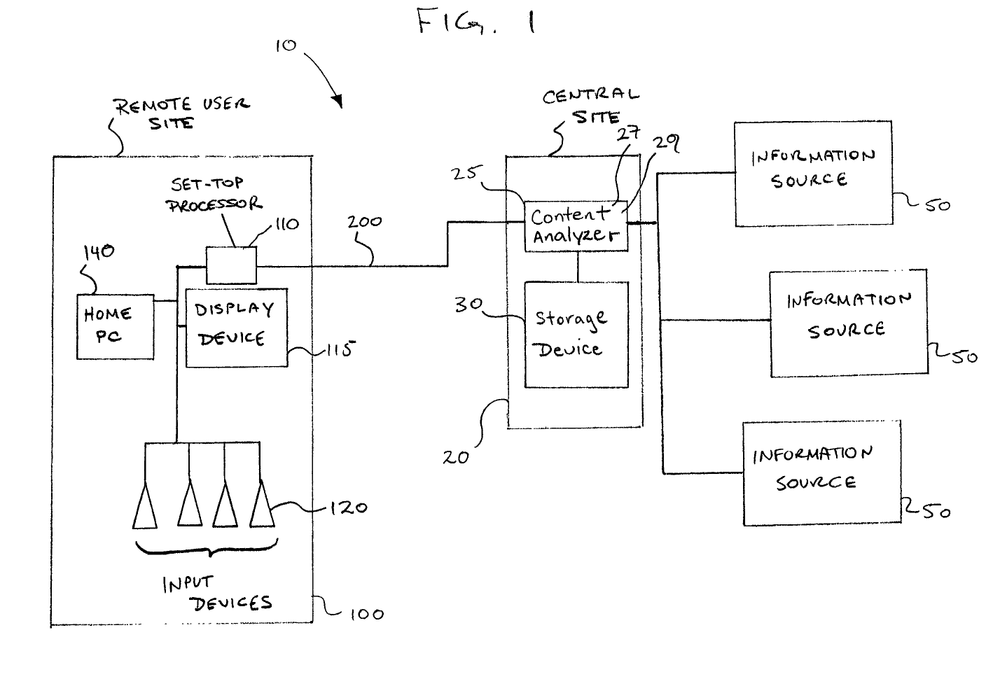

With reference to FIG. 1, there is shown a schematic overview of a first embodiment of an information retrieval system 10 in accordance with the present invention. A centralized content analysis system 20 is interconnected to a plurality of information sources 50. By way of non-limiting example, information sources 50 may include cable or satellite television and the Internet. The content analysis system 20 is also communicatively connected to a plurality of remote user sites 100, described further below.

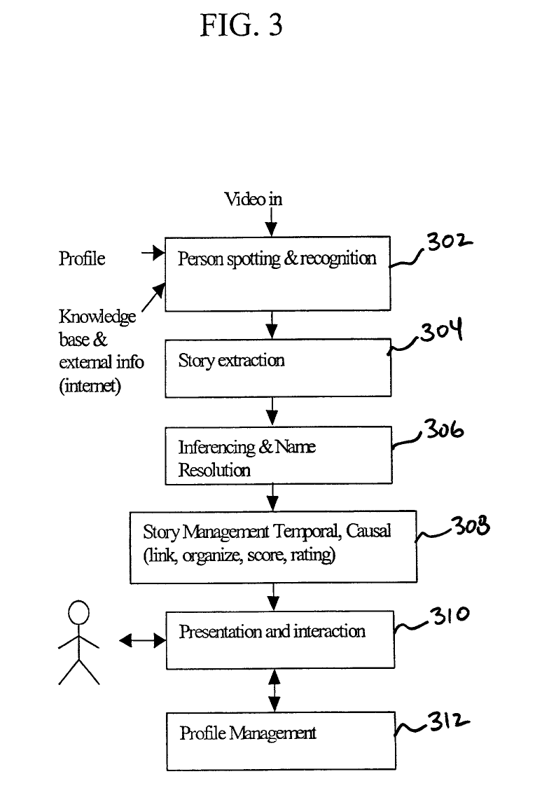

In the first embodiment, shown in FIG. 1, centralized content analysis system 20 comprises a content analyzer 25 and one or more data storage devices 30. The content analyzer 25 and the storage devices 30 are preferably interconnected via a local or wide area network. The content analyzer 25 comprises a processor 27 and a memory 29, which are capable of receiving and analyzing information received from the information sources 50. The processor 27 may be a microprocessor and associated operating memory (RAM and ROM), and include a second processor for pre-processing the video, audio and text components of the data input. The processor 27, which may be, for example, an Intel Pentium chip or other more powerful multiprocessor, is preferably powerful enough to perform content analysis on a frame-by-frame basis, as described below. The functionality of content analyzer 25 is described in further detail below in connection with FIGS. 3-5.

The storage devices 30 may be a disk array or may comprise a hierarchical storage system with tera, peta and exabytes of storage devices, optical storage devices, each preferably having hundreds or thousands of giga-bytes of storage capability for storing media content. One skilled in the art will recognize that any number of different storage devices 30 may be used to support the data storage needs of the centralized content analysis system 20 of an information retrieval system 10 that accesses several information sources 50 and can support multiple users at any given time.

As described above, the centralized content analysis system 20 is preferably communicatively connected to a plurality of remote user sites 100 (e.g., a user's home or office), via a network 200. Network 200 is any global communications network, including but not limited to the Internet, a wireless/satellite network, cable network, any the like. Preferably, network 200 is capable of transmitting data to the remote user sites 100 at relatively high data transfer rates to support media rich content retrieval, such as live or recorded television.

As shown in FIG. 1, each remote site 100 includes a set-top box 110 or other information receiving device. A set-top box is preferable because most set-top boxes, such as TiVo®, WebTB®, or UltimateTV®, are capable of receiving several different types of content. For instance, the UltimateTV® set-top box from Microsoft® can receive content data from both digital cable services and the Internet. Alternatively, a satellite television receiver could be connected to a computing device, such as a home personal computer 140, which can receive and process web content, via a home local area network. In either case, all of the information receiving devices are preferably connected to a display device 115, such as a television or CRT/LCD display.

Users at the remote user sites 100 generally access and communicate with the set-top box 110 or other information receiving device using various input devices 120, such as a keyboard, a multi-function remote control, voice activated device or microphone, or personal digital assistant. Using such input devices 120, users can input specific requests to the person tracker, which uses the requests search for information related to a particular person, as described further below.

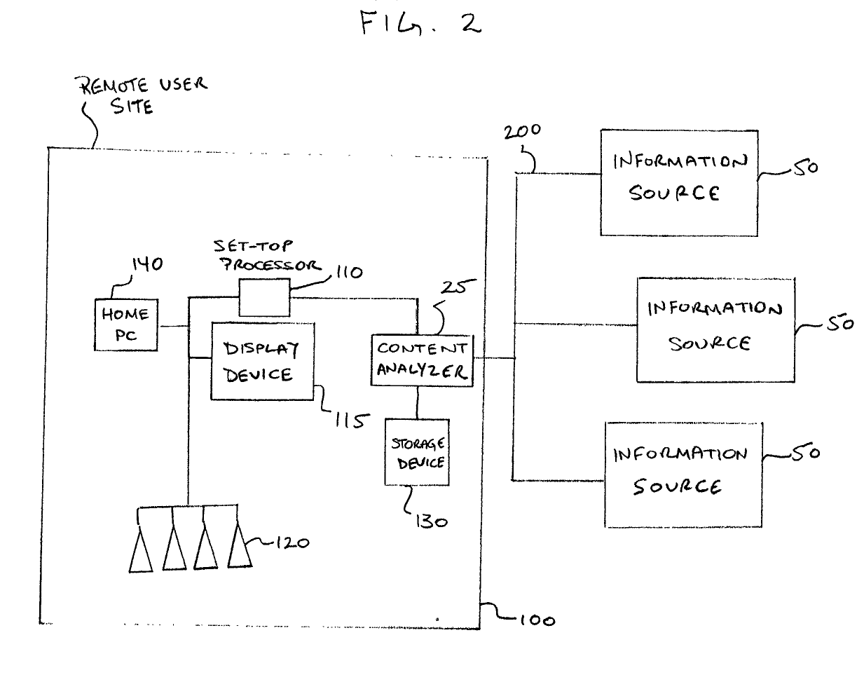

In an alternate embodiment, shown in FIG. 2, a content analyzer 25 is located at each remote site 100 and is communicatively connected to the information sources 50. In this alternate embodiment, the content analyzer 25 may be integrated with a high capacity storage device or a centralized storage device (not shown) can be utilized. In either instance, the need for a centralized analysis system 20 is eliminated in this embodiment. The content analyzer 25 may also be integrated into any other type of computing device 140 that is capable of receiving and analyzing information from the information sources 50, such as, by way of non-limiting example, a personal computer, a hand held computing device, a gaming console having increased processing and communications capabilities, a cable set-top box, and the like. A secondary processor, such as the TriMedia™ Tricodec card may be used in said computing device 140 to pre-process video signals. However, in FIG. 2 to avoid confusion, the content analyzer 25, the storage device 130, and the set-top box 110 are each depicted separately.

Functioning of Content Analyzer

As will become evident from the following discussion, the functionality of the information retrieval system 10 has equal applicability to both television/video based content and web-based content. The content analyzer 25 is preferably programmed with a firmware and software package to deliver the functionalities described herein. Upon connecting the content analyzer 25 to the appropriate devices, i.e., a television, home computer, cable network, etc., the user would preferably input a personal profile using input device 120 that will be stored in a memory 29 of the content analyzer 25. The personal profile may include information such as, for example, the user personal interests (e.g., sports, news, history, gossip, etc.), persons of interest (e.g., celebrities, politicians, etc.), or places of interest (e.g., foreign cities, famous sites, etc.), to name a few. Also, as described below, the content analyzer 25 preferably stores a knowledge base from which to draw known data relationships, such as G. W. Bush is the President of the United States.

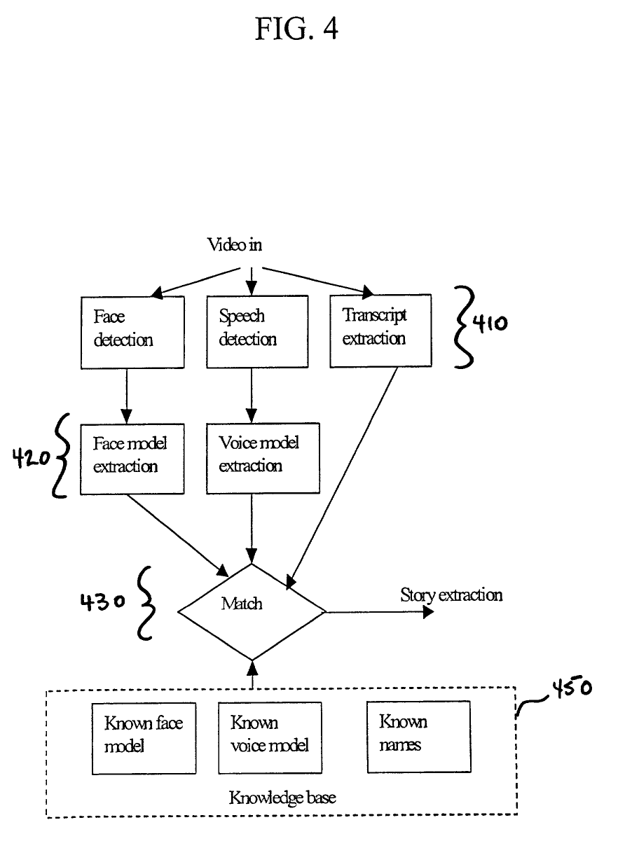

With reference to FIG. 3, the functionality of the content analyzer will be described in connection with the analysis of a video signal. In step 302, the content analyzer 25 performs a video content analysis using audio visual and transcript processing to perform person spotting and recognition using, for example, a list of celebrity or politician names, voices, or images in the user profile and/or knowledge base and external data source, as described below in connection with FIG. 4. In a real-time application, the incoming content stream (e.g., live cable television) is buffered either in the storage device 30 at the central site 20 or in the local storage device 130 at the remote site 100 during the content analysis phase. In other non-real-time applications, upon receipt of a request or other prescheduled event (described below), the content analyzer 25 accesses the storage device 30 or 130, as applicable, and performs the content analysis.

The content analyzer 25 of person tracking system 10 receives a viewer's request for information related to a certain celebrity shown in a program and uses the request to return a response, which can help the viewer better search or manage TV programs of interest. Here are four examples:

1. User is watching a cricket match. A new player comes to bat. The user asks the system 10 for detailed statistics on this player based on this match and previous matches this year.

2. User sees an interesting actor on the screen and wants to know more about him. The system 10 locates some profile information about the actor from the Internet or retrieves news about the actor from recently issued stories.

3. User sees an actress on the screen who looks familiar, but the user cannot remember the actress's name. System 10 responds with all the programs that this actress has been in along with her name.

4. A user who is very interested in the latest news involving a celebrity sets her personal video recorder to record all the news about the celebrity. The system 10 scans the news channels, and celebrity and talk shows, for example, for the celebrity and records of channels all matching programs.

Because most cable and satellite television signals carry hundreds of channels it is preferable to target only those channels that are most likely to produce relevant stories. For this purpose the content analyzer 25 may be programmed with knowledge base 450 or field database to aid the processor 27 in determining a “field types” for the user's request. For example, the name Dan Marino in the field database might be mapped to the field “sports”. Similarly, the term “terrorism” might be mapped to the field “news”. In either instance, upon determination of a field type, the content analyzer would then only scan those channels relevant to the field (e.g., news channels for the field “news”). While these categorizations are not required for operation of the content analysis process, using the user's request to determine a field type is more efficient and would lead to quicker story extraction. In addition, it should be noted that the mapping of particular terms to fields is a matter of design choice and could be implemented in any number of ways.

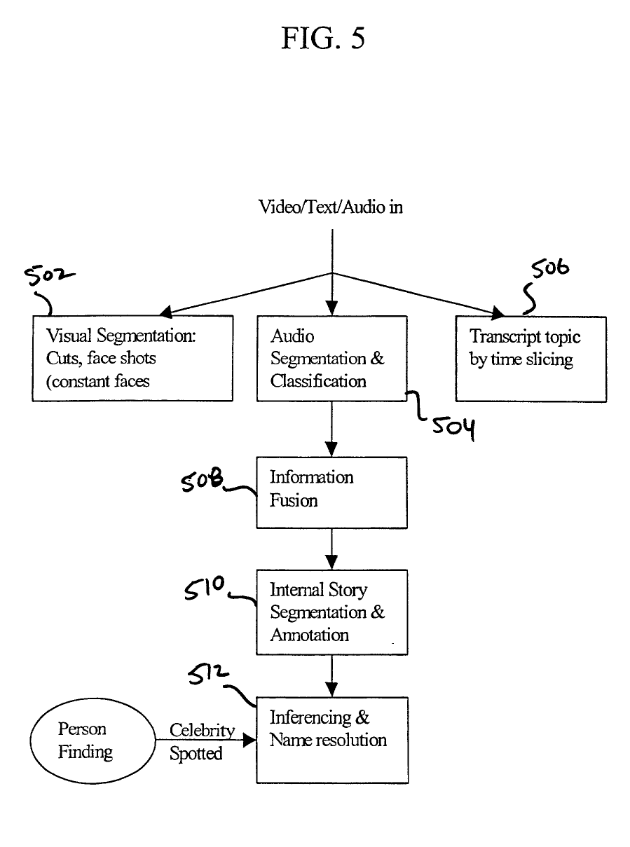

Next, in step 304, the video signal is further analyzed to extract stories from the incoming video. Again, the preferred process is described below in connection with FIG. 5. It should be noted that the person spotting and recognition can also be executed in parallel with story extraction as an alternative implementation.

An exemplary method of performing content analysis on a video signal, such as a television NTSC signal, which is the basis for both the person spotting and story extraction functionality, will now be described. Once the video signal is buffered, the processor 27 of the content analyzer 25, preferably uses a Bayesian or fusion software engine, as described below, to analyze the video signal. For example, each frame of the video signal may be analyzed so as to allow for the segmentation of the video data.

With reference to FIG. 4, a preferred process of performing person spotting and recognition will be described. At level 410, face detection, speech detection, and transcript extraction is performed substantially as described above. Next, at level 420, the content analyzer 25 performs face model and voice model extraction by matching the extracted faces and speech to known face and voice models stored in the knowledge base. The extracted transcript is also scanned to match known names stored in the knowledge base. At level 430, using the model extraction and name matches, a person is spotted or recognized by the content analyzer. This information is then used in conjunction with the story extraction functionality as shown in FIG. 5.

By way of example only, a user may be interested in political events in the mid-east, but will be away on vacation on a remote island in South East Asia; thus, unable to receive news updates. Using input device 120, the user can enter keywords associated with the request. For example, the user might enter Israel, Palestine, Iraq, Iran, Ariel Sharon, Saddam Hussein, etc. These key terms are stored in a user profile on a memory 29 of the content analyzer 25 As discussed above, a database of frequently used terms or persons is stored in the knowledge base of the content analyzer 25. The content analyzer 25 looks-up and matches the inputted key terms with terms stored in the database. For example, the name Ariel Sharon is matched to Israeli Prime Minister, Israel is matched to the mid-east, and so on. In this scenario, these terms might be linked to a news field type. In another example, the names of sports figures might return a sports field result.

Using the field result, the content analyzer 25 accesses the most likely areas of the information sources to find related content. For example, the information retrieval system might access news channels or news related web sites to find information related to the request terms.

With reference now to FIG. 5, an exemplary method of story extract will be described and shown. First, in steps 502, 504, and 506, the video/audio source is preferably analyzed to segment the content into visual, audio and textual components, as described below. Next, in steps 508 and 510, the content analyzer 25 performs information fusion and internal segmentation and annotation. Lastly, in step 512, using the person recognition result, the segmented story is inferenced and the names are resolved with the spotted subject.

Such methods of video segmentation include but are not limited to cut detection, face detection, text detection, motion estimation/segmentation/detection, camera motion, and the like. Furthermore, an audio component of the video signal may be analyzed. For example, audio segmentation includes but is not limited to speech to text conversion, audio effects and event detection, speaker identification, program identification, music classification, and dialogue detection based on speaker identification. Generally speaking, audio segmentation involves using low-level audio features such as bandwidth, energy and pitch of the audio data input. The audio data input may then be further separated into various components, such as music and speech. Yet further, a video signal may be accompanied by transcript data (for closed captioning system), which can also be analyzed by the processor 27. As will be described further below, in operation, upon receipt of a retrieval request from a user, the processor 27 calculates a probability of the occurrence of a story in the video signal based upon the plain language of the request and can extract the requested story.

Prior to performing segmentation, the processor 27 receives the video signal as it is buffered in a memory 29 of the content analyzer 25 and the content analyzer accesses the video signal. The processor 27 de-multiplexes the video signal to separate the signal into its video and audio components and in some instances a text component. Alternatively, the processor 27 attempts to detect whether the audio stream contains speech. An exemplary method of detecting speech in the audio stream is described below. If speech is detected, then the processor 27 converts the speech to text to create a time-stamped transcript of the video signal. The processor 27 then adds the text transcript as an additional stream to be analyzed.

Whether speech is detected or not, the processor 27 then attempts to determine segment boundaries, i.e., the beginning or end of a classifiable event. In a preferred embodiment, the processor 27 performs significant scene change detection first by extracting a new keyframe when it detects a significant difference between sequential I-frames of a group of pictures. As noted above, the frame grabbing and keyframe extracting can also be performed at pre-determined intervals. The processor 27 preferably, employs a DCT-based implementation for frame differencing using cumulative macroblock difference measure. Unicolor keyframes or frames that appear similar to previously extracted keyframes get filtered out using a one-byte frame signature. The processor 27 bases this probability on the relative amount above the threshold using the differences between the sequential I-frames.

A method of frame filtering is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For instance, when the processor begins analyzing the video signal, keyframes can be grabbed every 30 seconds.

Once these frames are grabbed every selected keyframe is analyzed. Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The audio component of the video signal may also be analyzed and monitored for the occurrence of words/sounds that are relevant to the user's request. Audio segmentation includes the following types of analysis of video programs: speech-to-text conversion, audio effects and event detection, speaker identification, program identification, music classification, and dialog detection based on speaker identification.

Audio segmentation and classification includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation and classification is known in the art and is generally explained in the publication by D. Li, I. K. Sethi, N. Dimitrova, and T. Mcgee, “Classification of general audio data for content-based retrieval,” Pattern Recognition Letters, pp. 533-544, Vol. 22, No. 5, April 2001, the entire disclosure of which is incorporated herein by reference.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automatic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Stories can be detected by identifying the sounds that may be associated with specific people or types of stories. For example, a lion roaring could be detected and the segment could then be characterized as a story about animals.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular celebrity or politician.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, N.Y. October 17-20, 1999.

Preferably, a multimodal processing of the video/text/audio is performed using either a Bayesian multimodal integration or a fusion approach. By way of example only, in an exemplary embodiment the parameters of the multimodal process include but are not limited to: the visual features, such as color, edge, and shape; audio parameters such as average energy, bandwidth, pitch, mel-frequency cepstral coefficients, linear prediction coding coefficients, and zero-crossings. Using such parameters, the processor 27 create the mid-level features, which are associated with whole frames or collections of frames, unlike the low-level parameters, which are associated with pixels or short time intervals. Keyframes (first frame of a shot, or a frame that is judged important), faces, and videotext are examples of mid-level visual features; silence, noise, speech, music, speech plus noise, speech plus speech, and speech plus music are examples of mid-level audio features; and keywords of the transcript along with associated categories make up the mid-level transcript features. High-level features describe semantic video content obtained through the integration of mid-level features across the different domains. In other words, the high level features represent the classification of segments according to user or manufacturer defined profiles, described further below.

The various components of the video, audio, and transcript text are then analyzed according to a high level table of known cues for various story types. Each category of story preferably has knowledge tree that is an association table of keywords and categories. These cues may be set by the user in a user profile or predetermined by a manufacturer. For instance, the “Minnesota Vikings” tree might include keywords such as sports, football, NFL, etc. In another example, a “presidential” story can be associated with visual segments, such as the presidential seal, pre-stored face data for George W. Bush, audio segments, such as cheering, and text segments, such as the word “president” and “Bush”. After a statistical processing, which is described below in further detail, the processor 27 performs categorization using category vote histograms. By way of example, if a word in the text file matches a knowledge base keyword, then the corresponding category gets a vote. The probability, for each category, is given by the ratio between the total number of votes per keyword and the total number of votes for a text segment.

In a preferred embodiment, the various components of the segmented audio, video, and text segments are integrated to extract a story or spot a face from the video signal Integration of the segmented audio, video, and text signals is preferred for complex extraction. For example, if the user desires to retrieve a speech given by a former president, not only is face recognition required (to identify the actor) but also speaker identification (to ensure the actor on the screen is speaking), speech to text conversion (to ensure the actor speaks the appropriate words) and motion estimation-segmentation-detection (to recognize the specified movements of the actor). Thus, an integrated approach to indexing is preferred and yields better results.

With respect to the Internet, the content analyzer 25 scans web sites looking for matching stories. Matching stories, if found, are stored in a memory 29 of the content analyzer 25. The content analyzer 25 may also extract terms from the request and pose a search query to major search engines to find additional matching stories. To increase accuracy, the retrieved stories may be matched to find the “intersection” stories. Intersection stories are those stories that were retrieved as a result of both the web site scan and the search query. A description of finding targeted information from a web site in order to find intersection stories is provided in “UniversityIE: Information Extraction From University Web Pages” by Angel Janevski, University of Kentucky, Jun. 28, 2000, UKY-COCS-2000-D-003, the entire disclosure of which is incorporated herein by reference.

In the case of television received from information sources 50, the content analyzer 25 targets channels most likely to have relevant content, such as known news or sports channels. The incoming video signal for the targeted channels is then buffered in a memory of the content analyzer 25, so that the content analyzer 25 perform video content analysis and transcript processing to extract relevant stories from the video signal, as described in detail above.

With reference again to FIG. 3, in step 306 the content analyzer 25 then performs “Inferencing and Name Resolution” on the extracted stories. For example, the content analyzer 25 programming uses an ontology. In other words, G. W. Bush is “The President of the United States of America” and the “Husband of Laura Bush”. Thus, if in one context the name G. W. Bush appears in the user profile then this fact is also expanded so that all of the above references are also found and the names/roles are resolved when they point to the same person.

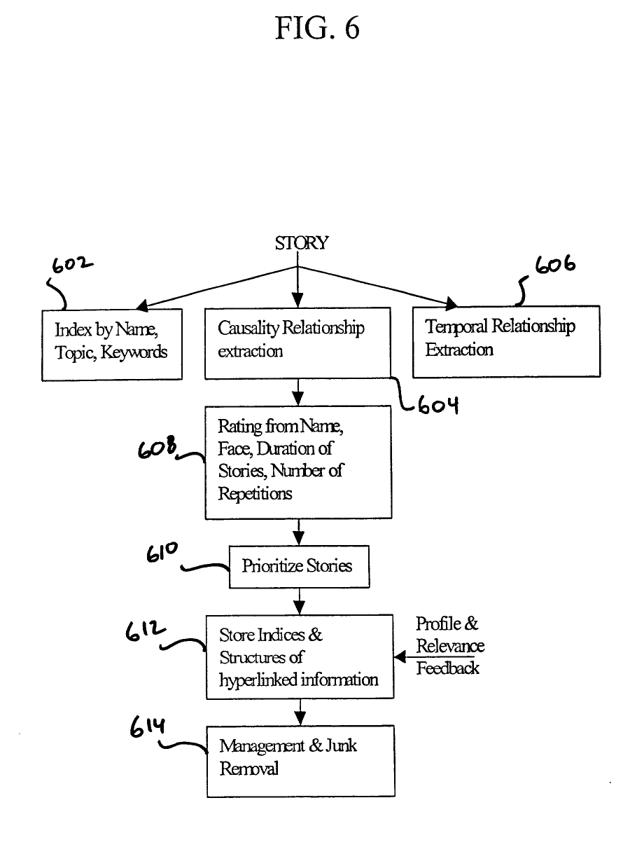

Once a sufficient number of relevant stories are extracted, in the case of television, and found, in the case of the Internet, the stories are preferably ordered based on various relationships, in step 308. With reference to FIG. 6, the stories are preferably indexed by name, topic, and keyword (602), as well as based on a causality relationship extraction (604). An example of a causality relationship is that a person first has to be charged with a murder and then there might be news items about the trial. Also, a temporal relationship (606), e.g., the more recent stories are ordered ahead of older stories, is then used to order the stories, is used to organize and rate the stories. Next, a story rating (608) is preferably derived and calculated from various characteristics of the extracted stories, such as the names and faces appearing in the story, the story's duration, and the number of repetitions of the story on the main news channels (i.e., how many times a story is being aired could correspond to its importance/urgency). Using these relationships, the stories are prioritized (610). Next, the indices and structures of hyperlinked information are stored according to information from the user profile and through relevance feedback of the user (612). Lastly, the information retrieval system performs management and junk removal (614). For example, the system would delete multiple copies of the same story, old stories, which are older than seven (7) days or any other pre-defined time interval.

It should be understood that a response to a request or particular criteria related to a targeted person (e.g., a celebrity) can be achieved in at least four different manners. First, the content analyzer 25 can have all of the resources necessary to retrieve relevant information stored locally. Second, the content analyzer 25 can recognize that it is lacking certain resources (e.g., it cannot recognize a celebrity's voice) and can send a sample of the voice pattern to an external server, which makes the recognition. Third, similar to example two above, the content analyzer 25 cannot identify a feature and requests samples from an external server from which a match can be made. Fourth, the content analyzer 25 searches for additional information from a secondary source, such as the Internet, to retrieve relevant resources, including but not limited to video, audio and images. In this way the content analyzer 25 has a greater probability of returning accurate information to the uses and can expand its knowledge base.

The content analyzer 25 may also support a presentation and interaction function (step 310), which allows the user to give the content analyzer 25 feedback on the relevancy and accuracy of the extraction. This feedback is utilized by profile management functioning (step 312) of the content analyzer 25 to update the user's profile and ensure proper inferences are made depending on the user's evolving tastes.

The user can store a preference as to how often the person tracking system would access information sources 50 to update the stories indexed in storage device 30, 130. By way of example, the system can be set to access and extract relevant stories either hourly, daily, weekly, or even monthly.

According to another exemplary embodiment, the person tracking system 10 can be utilized as a subscriber service. This could be achieved in one of two preferred manners. When the embodiment shown in FIG. 1, user could subscribe either through their television network provider, i.e., their cable or satellite provider, or a third party provider, which provider would house and operate the central storage system 30 and the content analyzer 25. At the user's remote site 100, the user would input request information using the input device 120 to communicate with a set top box 110 connected to their display device 115. This information would then be communicated to the centralized retrieval system 20 and processed by the content analyzer 25. The content analyzer 25 would then access the central storage database 30, as described above, to retrieve and extract stories relevant to the user's request.

Once stories are extracted and properly indexed, information related to how a user would access the extracted stories is communicated to the set top box 110 located at the user's remote site. Using the input device 120, the user can then select which of the stories he or she wishes to retrieve from the centralized content analysis system 20. This information may be communicated in the form of a HTML web page having hyperlinks or a menu system as is commonly found on many cable and satellite TV systems today. Once a particular story is selected, the story would then be communicated to the set top box 110 of the user and displayed on the display device 115. The user could also choose to forward the selected story to any number of friends, relatives or others having similar interests to receive such stories.

Alternatively, the person tracking system 10 of the present invention could be embodied in a product such as a digital recorder. The digital recorder could include the content analyzer 25 processing as well as a sufficient storage capacity to store the requisite content. Of course, one skilled in the art will recognize that a storage device 30, 130 could be located externally of the digital recorder and content analyzer 25. In addition, there is no need to house a digital recording system and content analyzer 25 in a single package either and the content analyzer 25 could also be packaged separately. In this example, a user would input request terms into the content analyzer 25 using the input device 120. The content analyzer 25 would be directly connected to one or more information sources 50. As the video signals, in the case of television, are buffered in memory of the content analyzer, content analysis can be performed on the video signal to extract relevant stories, as described above.

In the service environment, the various user profiles may be aggregated with request term data and used to target information to the user. This information may be in the form of advertisements, promotions, or targeted stories that the service provider believes would be interesting to the user based upon his/her profile and previous requests. In another marketing scheme, the aggregated information can be sold to their parties in the business of targeting advertisements or promotions to users.

While the invention has been described in connection with preferred embodiments, it will be understood that modifications thereof within the principles outlined above will be evident to those skilled in the art and thus, the invention is not limited to the preferred embodiments but is intended to encompass such modifications.

We claim:

1. A system for retrieving information regarding a targeted person, comprising:
a content analyzer comprising a memory and a processor, the content analyzer communicatively connected to a first external source for receiving content, and the processor being operative with programming to analyze the content according to a criteria;
a knowledge base being stored in the memory of the content analyzer, the knowledge base including a plurality of known relationships; and
wherein, according to the criteria, the processor of the content analyzer searches the content to identify the targeted person and uses the known relationships in the knowledge base to retrieve information related to the targeted person.

2. The system of claim 1, further comprising a user profile stored in the memory of the content analyzer, the user profile including information about interests of a user of the system, and wherein the criteria comprises information in the user profile.

3. The system of claim 2, wherein the user profile is updated by integrating information in the request with existing information in the user profile.

4. The system of claim 2, further comprising an input device communicatively connected to the content analyzer for permitting the user to input information into the user profile or transmit a request to the content analyzer.

5. The system of claim 4, wherein the criteria comprises information from the request.

6. The system of claim 1, wherein the knowledge base is an ontology of related information.

7. The system of claim 1, wherein one type of the known relationships is a map of a known face to a name.

8. The system of claim 1, wherein one type of the known relationships is a map of a known voice to a name.

9. The system of claim 1, wherein one type of the known relationships is a map of a name to various related information.

10. The system of claim 1, wherein one of the known relationships is a map of a known name to occupation.

11. The system of claim 1, wherein one of the known relationships is a map of a known name to a family relationship.

12. The system of claim 1, wherein one of the known relationships is a map of an actor name to a role.

13. The system of claim 1, wherein the content is a video signal.

14. The system of claim 13, wherein the first external source is a cable television provider.

15. The system of claim 13, wherein the first external source is a satellite television provider.

16. The system of claim 1, wherein the content is graphical and textual data.

17. The system of claim 16, wherein the first external source is the Internet.

18. The system of claim 16, wherein the first external source is a database of information.

19. The system of claim 1, wherein the content analyzer is communicatively connected to a second external source and wherein the second external source is searched according the criteria to retrieve additional information related to the targeted person.

20. The system of claim 1, wherein the content analyzer is further operative with a person spotting function to extract faces, speech, and text from the content.

21. The system of claim 20, wherein the person spotting function operates to:
make a first match of known faces to the extracted faces;
make a second match of known voices to the extracted voices;
scan the extracted text to make a third match to known names; and
calculate a probability of a particular person being present in the content based on the first, second, and third matches.

22. The system of claim 1, further comprising a display device connected to the content analyzer for permitting a user to interact with the content analyzer.

23. The system of claim 22, wherein a set of results compiled by the content analyzer according to the criteria is displayed on the display device.

24. The system of claim 23, wherein the set of results is displayed as one or more links on the display device.

25. The system of claim 24, wherein, in addition to the links, the content analyzer displays one or more secondary links to a shopping a web-site such that the user can purchase goods related to the targeted person.

26. The system of claim 1, wherein the content analyzer transmits a request to an external server, the server using the request to search an external server to return clues to the content analyzer usable in determining identifying the targeted person.

27. A method of retrieving information related to a targeted person, the method comprising:
(a) receiving a video source from a first external into a memory of a content analyzer;
(b) receiving a request from a user to retrieve information related to the targeted person;
(c) analyzing the video source to spot the targeted person in a program;
(d) scanning additional channels of the video source for information related to the targeted person;
(e) searching a second external source to retrieve further information related to the targeted subject;
(f) retrieving the information found as a result of steps (d) and (e); and
(g) displaying the results on a display device communicatively connected to the content analyzer.

28. The method of claim 27, wherein step (c) comprises extracting faces, speech, and text from the video source, making a first match of known faces to the extracted faces, making a second match of known voices to the extracted voices, scanning the extracted text to make a third match to known names, and calculating a probability of the targeted person being present in the video source based on the first, second, and third matches.

29. The method of claim 27, further comprising resolving relationships and inferencing names using an ontology.

30. The method of claim 28, further comprising calculating the probability using a known relationship.

31. The method of claim 30, wherein the known relationship is a map of a name to an occupation.

32. The method of claim 30, wherein the known relationship is a map of a name to a family relationship.

33. The method of claim 30, wherein the known relationship is a map of an actor's name to a role.

34. A person tracking retrieval system, comprising:
a centrally located content analyzer in communication with a storage device, the content analyzer being accessible to a plurality of users and information sources via a communications network, and the content analyzer being programmed with a set of machine-readable instructions to:
receive first content data into the content analyzer;
receive a request from at least one of the users;
in response to receipt of the request, analyze the first content data to extract information relevant to the request; and
provide access to the information.
